(19) United States
(12) Patent Application Publication
(10) Pub. No.: US 2007/0220749 A1
(43) Pub. Date: Sep. 27, 2007

(54) Method of designing tooth profile for internal gear type pump

(75) Inventor: Jin Wuk Lee, Daegu (KR)

Correspondence Address: MAYER, BROWN, ROWE & MAW LLP, 1909 K STREET, N.W., WASHINGTON, DC, 20006, US

(73) Assignee: Korea Sintered Metal Co., Ltd.

(21) Appl. No.: 11/418,140

(22) Filed: May 5, 2006

(30) Foreign Application Priority Data
Mar. 24, 2006 (KR) 10-2006-0027085

(51) Int. Cl. B23P 15/14

(52) U.S. Cl. 29/893; 29/893.3

(57) ABSTRACT

Disclosed is a method of designing a tooth profile for an internal gear type pump. The method includes revolving a rolling circle, which has an eccentric distance less than the diameter of the rolling circle, around a base circle while the rolling circle is rotating about its center in such a manner that the rolling circle contacting with the base circle, forming a trochoidal curve outside the base circle, the trochoidal curve being formed by the eccentric point of the rolling circle during the revolution of the rolling circle accomplished while the rolling circle is rotating about its center, and generating an envelope by revolving a trajectory circle along the trochoidal curve while the trajectory circle is rotating on its center in such a manner that the center of the trajectory circle is on the trochoidal curve, the envelope being a trochoidal tooth profile. An improved trajectory ellipse is provided.

### BACKGROUND OF THE INVENTION

1. Field of the Invention

The present invention relates to a method of designing a tooth profile for an internal gear type pump, and, more particularly, to a method of designing a tooth profile for an internal gear type pump that is capable of increasing the discharge amount of the pump, and therefore, improving the efficiency of the pump.

2. Description of the Related Art

An internal gear type pump has been variously applied to a general industrial field, an automobile field, etc. Especially in the automobile field, the internal gear type pump is applied to an engine oil pump, a transmission oil pump, a fuel pump, etc. The internal gear type pump, which includes an outer gear mounted in a pump body, and an inner gear engaged with the outer gear while the inner gear is inscribed in the outer gear, serves to discharge a fluid.

Various methods of designing a tooth profile of an inner gear applied to the above-described pump have been developed or proposed, a typical example of which is a method of designing a trochoidal tooth profile.

In the trochoidal tooth profile design method, the number of teeth for the outer gear is greater by one than that for the inner gear, and a rolling circle B, which has an eccentric distance e less than the diameter of the rolling circle B, revolves around a base circle A while the rolling circle B is rotating about its center in such a manner that the rolling circle B is in contact with the base circle A.

A curve, i.e., a trochoidal curve D, is formed by the eccentric point of the rolling circle B during the revolution of the rolling circle B. The trochoidal curve D is formed outside the base circle A. And a trajectory circle C revolves while the trajectory circle C is rotating on its center in such a manner that the center of the trajectory circle C is on the trochoidal curve D, which results in an envelope E. This envelope E is a trochoidal tooth profile.

Here, in order for the rolling circle B to be returned to its original position after one revolution of the rolling circle B around the circumference of the base circle, the following equation is to be satisfied.

A=nB (here, n is the number of teeth for the inner gear)

The outer gear is formed by dividing the circumferences of the base circle A and the rolling circle B into n+1 equal parts and locating the center of the trajectory circle C on the n+1 dividing points.

Alternatively, an outer gear, which has n+1 teeth, is prepared (at this time, the center of the trajectory circle is located on the circumferences of the base circle and the rolling circle), and the outer gear revolves n+1 times (the number of teeth for the outer gear) along a trajectory formed by the radial eccentric distance e while the outer gear is rotating once about the center of an inner gear (when the outer gear revolves once, the outer gear rotates 1/n+1 times), which results in an envelope of the outer gear trajectory. The tooth profile of the inner gear is formed by the envelope of the outer gear trajectory.

On the other hand, the inner gear revolves n times along the trajectory formed by the radial eccentric distance e while the inner gear is rotating once about the center of the outer gear, which results in an envelope of the inner gear trajectory. The tooth profile of the outer gear is formed by the envelope of the inner gear trajectory.

In the conventional trochoidal tooth profile design method, on the assumption that the major axis of the outer gear O is d1, the minor axis of the outer gear O is d2, the major axis of the inner gear I is d3, and the minor axis of the inner gear I is d4, the discharge amount is decided depending upon the eccentric distance e, which is the center distance between the inner gear I and the outer gear O, between the major axis d1 of the outer gear O and the minor axis d4 of the inner gear I.

The height of teeth for the inner gear I and the outer gear O is expressed by the following equations.
d1=d2+4e,d3=d4+4e=d2+2e

On the assumption that the space volume, when the space formed by the tooth profile of the inner gear I and the tooth profile of the outer gear O is the maximum, is V1, and the space volume, when the space formed by the tooth profile of the inner gear I and the tooth profile of the outer gear O is the minimum, is V2, the theoretical discharge amount accomplished through one revolution of the inner gear I having the above-described trochoidal tooth profile is expressed by the following equation.

Theoretical discharge amount (Vth)=(V1−V2)×n (here, n is the number of teeth for the inner gear)

In the conventional trochoidal tooth profile design method, on the assumption that the number of teeth for the inner gear I is 9 (the number of teeth for the outer gear O is 10), the diameter of the base circle is Φ64.26 mm, the diameter of the rolling circle is Φ7.14 mm, the diameter of the trajectory circle is Φ13.030 mm, the eccentric distance is 3.222 mm, the major axis of the inner gear is Φ64.8236 mm, the minor axis of the inner gear is Φ51.9156 mm, the major axis of the outer gear is Φ71.2776 mm, and the minor axis of the outer gear is Φ58.3696 mm, the theoretical discharge amount is 11.7 cm³/rev.

When the inner gear and the outer gear are practically manufactured, the tooth profile of the inner gear or the outer gear is deformed, for example, through offset or scale change, to provide a slight assembly gap between the inner gear and the outer gear, whereby the smooth revolution of the inner gear and the outer gear is accomplished.

In the conventional trochoidal tooth profile design method, however, the eccentric distance e is restricted. As a result, there is a limit to increase the theoretical discharge amount, and therefore, it is not possible to greatly increase the efficiency of the pump. Consequently, it is necessary to increase the size of the pump.

### SUMMARY OF THE INVENTION

Therefore, the present invention has been made in view of the above problems, and it is an object of the present invention to provide a method of designing a tooth profile for an internal gear type pump that is capable of increasing the discharge amount of the pump without increasing the size of the pump, thereby designing a small-sized pump having the maximum flow rate, and therefore, manufacturing a pump having excellent durability and high efficiency.

In accordance with the present invention, the above and other objects can be accomplished by the provision of a method of designing a tooth profile for an internal gear type pump including an outer gear and an inner gear, the number of teeth for the outer gear being greater by one than that for the inner gear, the method comprising the steps of: revolving a rolling circle, which has an eccentric distance less than the diameter of the rolling circle, around a base circle while the rolling circle is rotating about its center in such a manner that the rolling circle is in contact with the base circle; forming a trochoidal curve outside the base circle, the trochoidal curve being formed by the eccentric point of the rolling circle during the revolution of the rolling circle accomplished while the rolling circle is rotating about its center; and generating an envelope by revolving a trajectory circle along the trochoidal curve while the trajectory circle is rotating on its center in such a manner that the center of the trajectory circle is on the trochoidal curve, the envelope being a trochoidal tooth profile, wherein a trajectory ellipse having a major axis of a and a minor axis of b is applied, instead of the trajectory circle, which moves along the trochoidal curve while the trajectory circle is rotating on its center, such that the eccentric distance is increased by (a−b)/4, whereby the discharge amount is increased.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a view illustrating a conventional method of designing a tooth profile for an internal gear type pump;

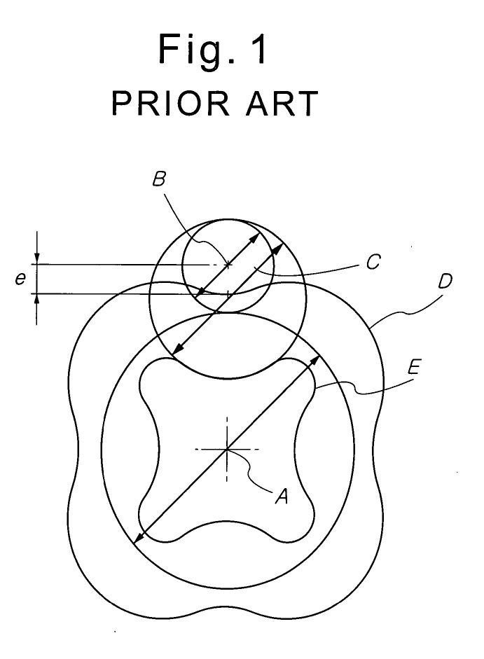

FIG. 2 is a view illustrating an inner gear and an outer gear of an internal gear type pump, which are designed by the conventional tooth profile design method;

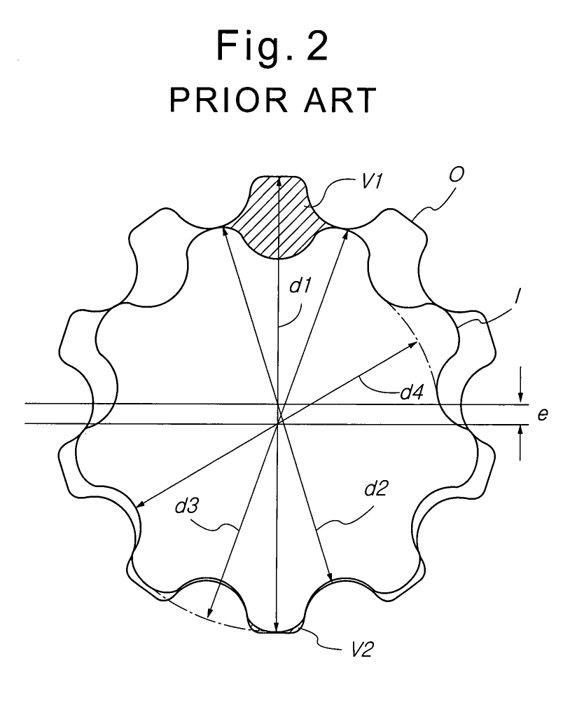

FIG. 3 is a view illustrating a method of designing an inner gear tooth profile for an internal gear type pump according to the present invention;

FIG. 4 is an enlarged view of the part A of FIG. 3, more clearly illustrating the inner gear tooth profile design method according to the present invention;

FIG. 5 is a view illustrating an outer gear designed by the inner gear tooth profile design method according to the present invention;

FIG. 6 is a view illustrating an inner gear and an outer gear of an internal gear type pump, which are designed by the inner gear tooth profile design method according to the present invention; and

FIG. 7 is a table illustrating the comparison between a theoretical discharge amount accomplished by the tooth profile according to the present invention and a theoretical discharge amount accomplished by the conventional tooth profile.

### DESCRIPTION OF THE PREFERRED EMBODIMENTS

Now, a preferred embodiment of the present invention will be described in detail with reference to the accompanying drawings.

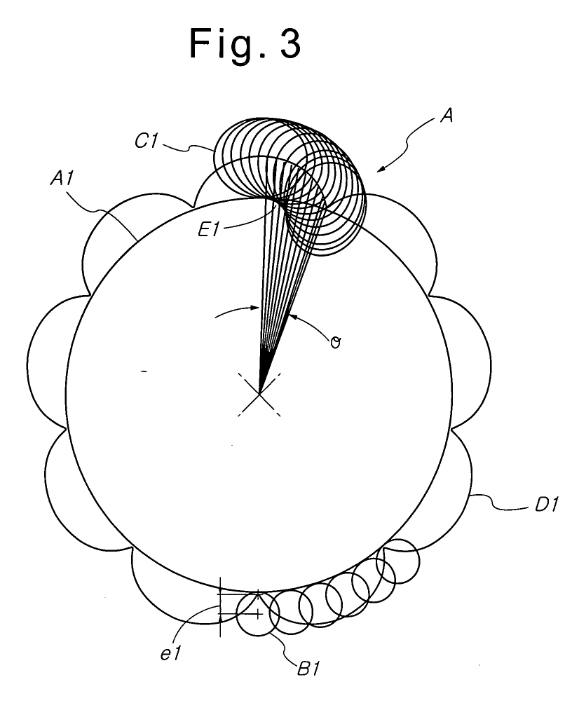

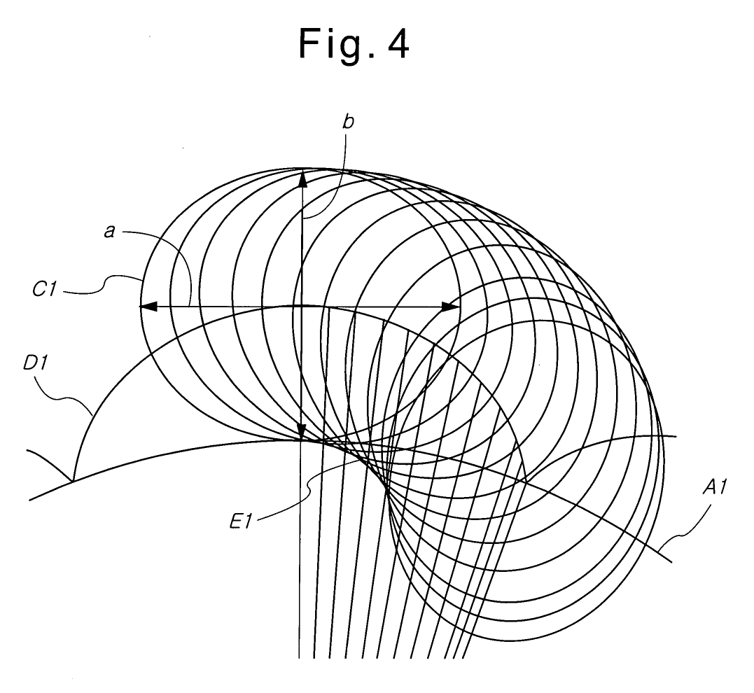

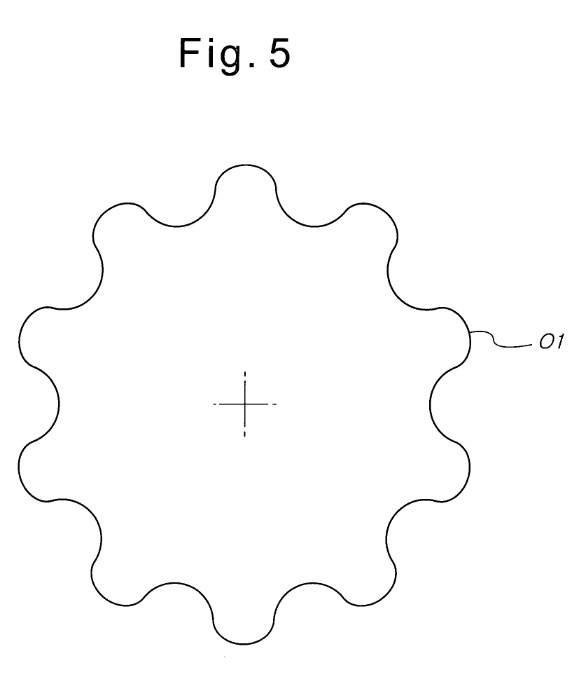

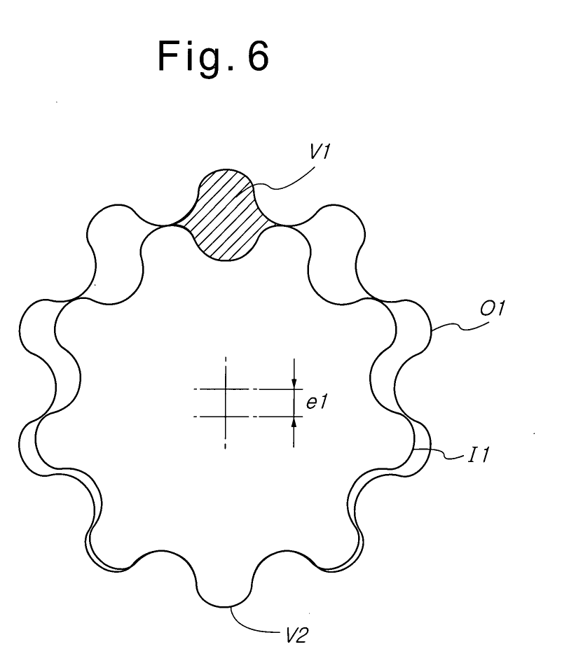

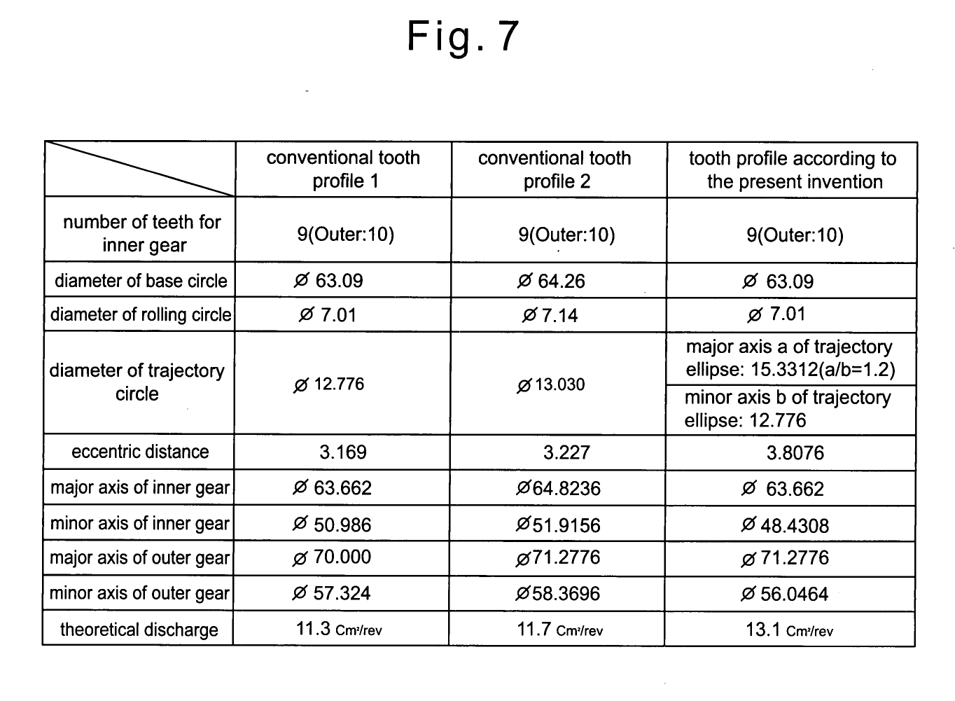

FIG. 3 is a view illustrating a method of designing an inner gear tooth profile for an internal gear type pump according to the present invention, FIG. 4 is an enlarged view of the part A of FIG. 3, more clearly illustrating the inner gear tooth profile design method according to the present invention, FIG. 5 is a view illustrating an outer gear designed by the inner gear tooth profile design method according to the present invention, FIG. 6 is a view illustrating an inner gear and an outer gear of an internal gear type pump, which are designed by the inner gear tooth profile design method according to the present invention, and FIG. 7 is a table illustrating the comparison between a theoretical discharge amount accomplished by the tooth profile according to the present invention and a theoretical discharge amount accomplished by the conventional tooth profile.

The number of teeth for an outer gear O1 is greater by one than that for an inner gear I1, and a rolling circle B1, which has an eccentric distance e1 less than the diameter of the rolling circle B1, revolves around a base circle A1 while the rolling circle B1 is rotating about its center in such a manner that the rolling circle B1 is in contact with the base circle A1.

A curve, i.e., a trochoidal curve D1, is formed by the eccentric point of the rolling circle B1 during the revolution of the rolling circle B1 accomplished while the rolling circle B1 is rotating about its center. The trochoidal curve D1 is formed outside the base circle A1. And a trajectory circle revolves along the trochoidal curve D1 while the trajectory circle is rotating on its center in such a manner that the center of the trajectory circle is on the trochoidal curve D1, which results in an envelope E1. This envelope E1 is a trochoidal tooth profile.

According to the present invention, a trajectory ellipse C1 having a major axis of a and a minor axis of b is applied, instead of the trajectory circle, which moves along the trochoidal curve D1 while the trajectory circle is rotating on its center, such that the eccentric distance e1 is increased by (a−b)/4, whereby the discharge amount is increased.

Preferably, a/b is 1 or more. However, if a/b is 1.5 or more, the envelope is sharp, and therefore, it is difficult to construct the inner gear or the outer gear.

When the eccentric point of the trajectory ellipse C1 is outermost, the minor axis b of the trajectory ellipse C1 is located in the central direction, and the major axis a of the trajectory ellipse C1 is located in the direction perpendicular to the central direction. In this state, when the trajectory ellipse C1 revolves along the trajectory of the eccentric point by θ° about the center of the base circle A1, the trajectory ellipse C1 rotates by θ×(90°+180°/n)×n/180° (here, n is the number of teeth for the inner gear, which is arbitrarily chosen). In this way, the envelope E1 of the ellipse trajectory is formed. This envelope E1 is the tooth profile for the inner gear I1.

At this time, the eccentric distance e1=e (the conventional eccentric distance)+(a+b)/4, and therefore, the eccentric distance e1 according to the present invention is greater than the conventional eccentric distance e.

In the case of the outer gear, the inner gear revolves n times along the trajectory formed by the radial eccentric distance e+(a+b)/4 while the inner gear is rotating once about the center of the outer gear, which results in an envelope of the inner gear trajectory. The tooth profile of the outer gear is formed by the envelope of the inner gear trajectory.

Hereinafter, the comparison between the theoretical discharge amount accomplished by the tooth profile according to the present invention and the theoretical discharge amount accomplished by the conventional tooth profile will be made in order to confirm that the theoretical discharge amount according to the present invention is greater than the conventional theoretical discharge amount. When the base circle and the rolling circle according to the present invention are identical to the base circle and the rolling circle according to the conventional art, and the trajectory ellipse is applied according to the present invention, the discharge amount is as follows.

On the assumption that the number of teeth for the inner gear I1 is 9 (the number of teeth for the outer gear is 10), the diameter of the base circle is Φ63.09 mm, the diameter of the rolling circle is Φ7.01 mm, the major axis of the trajectory ellipse is 15.3312 (a/b=1.2) mm, the minor axis of the trajectory ellipse is 12.776 mm, the eccentric distance is 3.8078 mm, the major axis of the inner gear is Φ63.662 mm, the minor axis of the inner gear is Φ48.4308 mm, the major axis of the outer gear is Φ71.2776 mm, and the minor axis of the outer gear is Φ58.0464 mm, the theoretical discharge amount is 13.1 cm³/rev, which is greater than 11.3 cm³/rev, which is the conventional theoretical discharge amount.

Even when the major axis of the outer gear according to the present invention is equal to the major axis of the outer gear according to the conventional art, and the trajectory ellipse is applied according to the present invention, on the other hand, the theoretical discharge amount according to the present invention is greater than the conventional theoretical discharge amount, as can be confirmed from the comparison table of FIG. 7.

As apparent from the above description, the present invention provides a method of designing a tooth profile for an internal gear type pump that is capable of increasing the discharge amount of the pump without increasing the size of the pump. Consequently, the present invention has the effect of designing a small-sized pump having the maximum flow rate, and therefore, manufacturing a pump having excellent durability and high efficiency.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

What is claimed is:

1. A method of designing a tooth profile for an internal gear type pump including an outer gear and an inner gear, the number of teeth for the outer gear being greater by one than that for the inner gear, the method comprising the steps of:
revolving a rolling circle, which has an eccentric distance less than the diameter of the rolling circle, around a base circle while the rolling circle is rotating about its center in such a manner that the rolling circle is in contact with the base circle;
forming a trochoidal curve outside the base circle, the trochoidal curve being formed by the eccentric point of the rolling circle during the revolution of the rolling circle accomplished while the rolling circle is rotating about its center; and
generating an envelope by revolving a trajectory circle along the trochoidal curve while the trajectory circle is rotating on its center in such a manner that the center of the trajectory circle is on the trochoidal curve, the envelope being a trochoidal tooth profile, wherein
a trajectory ellipse having a major axis of a and a minor axis of b is applied, instead of the trajectory circle, which moves along the trochoidal curve while the trajectory circle is rotating on its center, such that the eccentric distance is increased by (a−b)/4, whereby the discharge amount is increased.

2. The method as set forth in claim 1, wherein
when the eccentric point of the trajectory ellipse is outermost, the minor axis of the trajectory ellipse is located in the central direction, and the major axis of the trajectory ellipse is located in the direction perpendicular to the central direction, and
in this state, when the trajectory ellipse revolves along the trajectory of the eccentric point by θ° about the center of the base circle, the trajectory ellipse rotates by θ ×(90°+180°/n)×n/180° (here, n is the number of teeth for the inner gear), which results in an envelope of the ellipse trajectory, the envelope being a tooth profile for the inner gear.
